(19) United States
(12) Patent Application Publication
(10) Pub. No.: US 2023/0373311 A1
(43) Pub. Date: Nov. 23, 2023

(54) ZIP LINE TROLLEY WITH MAGNETIC EDDY CURRENT BRAKING AND HEAT DISSIPATION SYSTEM

(71) Applicant: Ronald Delbert Schapf, Glendale, CA (US)

(72) Inventor: Ronald Delbert Schapf, Glendale, CA (US)

(21) Appl. No.: 18/042,665

(22) PCT Filed: Sep. 10, 2021
(86) PCT No.: PCT/CA2021/051258

§ 371 Date: Feb. 23, 2023

Related U.S. Application Data
(60) Provisional application No. 63/076,570, filed on Sep. 10, 2020.

(51) Int. Cl. B60L 5/04; B61B 3/02

(52) U.S. Cl. CPC B60L 5/04; B61B 3/02

(57) ABSTRACT

A zip line trolley for movement along a tensioned support member, such as a cable, with an eddy current braking system including non-ferrous electrically conductive components between which there is rotatably supported at least one wheel rollingly engaged with the cable and carrying magnetic devices which induce eddy currents in the side plates to brake the respective wheel, features a cooling system thermally coupled to the side plate arranged to carry the eddy current, so as to receive heat generated by the induced eddy currents, and configured to release the received heat to ambient air as the trolley moves along the cable. According to another aspect, the braking system features magnetic assemblies supported for generally radially-directed sliding movement on at least one of the wheels and a distinct annular component, which is conducive to carrying eddy currents, and which registered with an outward-most location of the sliding magnetic assemblies.

### FIELD OF THE INVENTION

The present invention relates generally to a zip line trolley with magnetic eddy current braking, and more particularly to such a trolley with a heat dissipation system for dissipating heat generated during braking.

### BACKGROUND

U.S. Pat. No. 10,065,507, as one example, shows a zip line trolley configured to generate eddy currents that cause braking of the trolley. However, eddy currents generate a significant amount of heat which can cause the trolley to fail.

### SUMMARY OF THE INVENTION

According to an aspect of the invention there is provided a trolley for movement along a tensioned support member spanning from a first location to a second location, the trolley comprising:
a housing having a leading end and longitudinally opposite trailing end and configured to receive the tensioned support member therethrough, wherein the housing comprises a pair of upstanding side plates supported in generally-parallel laterally spaced-apart relation and arranged on either side of the tensioned support member, wherein the side plates are metallic;
at least one wheel supported by the housing between the side plates, wherein the at least one wheel is configured for rolling engagement with the tensioned support member and is rotatable around a wheel axis which is laterally oriented; and
a braking system mounted to the at least one wheel and configured to induce eddy currents that act to oppose rotation of the at least one wheel, wherein the braking system comprises:
a plurality of magnetic devices respectively configured to generate magnetic fields, wherein the magnetic devices are supported on a respective one of the at least one wheel to rotate around the wheel axis therewith, wherein the magnetic devices are disposed in proximity to a proximal one of the side plates such that the magnetic fields of the magnetic assemblies passes through the proximal side plate;
an eddy current-carrying portion on the proximal side plate, which is non-ferrous and electrically conductive;
wherein the magnetic devices are movable relative to the respective wheel between an inactive position, in which substantially no eddy currents are induced in the eddy current-carrying portion, and a deployed position in which eddy currents are inducible in the eddy current-carrying portion for opposing rotation of the respective wheel for braking thereof;
wherein the magnetic devices are configured to move from the inactive position to the deployed position based on rotational speed of the respective wheel; and
a cooling system thermally coupled to the eddy current-carrying portion to receive heat generated by the induced eddy currents;
wherein the cooling system is configured for releasing the received heat to ambient air as the trolley moves along the tensioned support member.

This arrangement provides a manner of disposing of heat generated by induced eddy currents so that the trolley with eddy current brake system can be used in applications where prolonged or more aggressive braking of the trolley is needed, such as on steep slopes.

In one arrangement, the cooling system comprises a plurality of passive heat exchanger members arranged on a face of the eddy current-carrying portion, the passive heat exchanger members have exterior surfaces arranged to be exposed to the ambient air, and a total surface area of the exterior surfaces of the passive heat exchanger members is greater than a surface area of the face of the eddy current-carrying portion.

In one arrangement, the passive heat exchanger members are arranged on an exterior face of the eddy current-carrying portion opposite to the at least one wheel.

In one arrangement, the passive heat exchanger members comprise fins projecting from the face of the eddy current-carrying portion and made from thermally conductive material.

In one such arrangement, the fins extend longitudinally of the housing.

In one arrangement, each of the fins extends along a linear path on the face of the eddy current-carrying portion.

In one arrangement, the fins are arranged in side-by-side relation on the face of the eddy current-carrying portion.

In one arrangement, the fins are arranged on the face of the eddy current-carrying portion so that each adjacent pair of the fins forms a longitudinally extending duct on the face of the eddy current-carrying portion.

In one such arrangement, the trolley includes at least one longitudinally-extending covering member spanning between free tips of the fins to close the ducts.

In one such arrangement, the at least one covering member forms an air-scoop delimiting an inlet opening outwardly of the free tips of the fins.

In one such arrangement, the at least one covering member forms a plurality of air-scoops each delimiting an inlet opening outwardly of the free tips of the fins, the air-scoops being located at longitudinally spaced positions so as to provide a leading one of the air-scoops at a front end of the proximal side plate and at least one trailing air-scoop rearwardly thereof, and the inlet opening of said at least one trailing air-scoop being larger than the inlet opening of the leading one of the air-scoops.

In another arrangement, the passive heat exchanger members comprise thermally conductive bodies each defining an enclosed interior cavity containing a phase-change fluid, each thermally conductive body having a base portion in thermal contact with the eddy current-carrying portion and a free portion arranged in thermal contact with the ambient air, such that the phase-change fluid is enabled to receive heat from the eddy current-carrying portion at the base portion of the thermally conductive body and to release the heat at the free portion.

In one such arrangement, the trolley further includes a duct member supported adjacent the thermally conductive bodies, wherein the duct member forms an air-scoop delimiting an inlet opening outwardly of the passive heat exchanger members.

Typically, the at least one wheel is freewheeling.

In one arrangement, the eddy current-carrying portion is distinct from the proximal side plate.

In one such arrangement, the eddy current-carrying portion is supported in a recess on an interior side of the proximal side plate adjacent the at least one wheel.

In one such arrangement, the proximal side plate comprises one or more openings registered with the eddy current-carrying portion and the cooling system passes therethrough to an exterior of the housing.

According to another aspect of the invention there is provided a trolley for movement along a tensioned support member spanning from a first location to a second location, the trolley comprising:
a housing configured to receive the tensioned support member therethrough, wherein the housing comprises a pair of upstanding side plates supported in generally-parallel laterally spaced-apart relation and arranged on either side of the tensioned support member, wherein the side plates are metallic;
at least one wheel supported by the housing between the side plates, wherein the at least one wheel is configured for rolling engagement with the tensioned support member and is rotatable around a wheel axis which is laterally oriented; and
a braking system mounted to the at least one wheel and configured to induce eddy currents that act to oppose rotation of the at least one wheel, wherein the braking system comprises:
a plurality of magnetic assemblies respectively configured to generate magnetic fields, wherein the magnetic assemblies are supported on a respective one of the at least one wheel to rotate around the wheel axis therewith, wherein the magnetic assemblies are disposed in proximity to a proximal one of the side plates such that the magnetic fields of the magnetic assemblies passes through the proximal side plate;
wherein the magnetic assemblies are slidably movable relative to the respective wheel between an inactive position, in which the magnetic assemblies are located at inwardly spaced locations from a circumference of the at least one wheel, and a deployed position in which the magnetic assemblies are located radially outward from the inactive position;
wherein the magnetic assemblies are configured to move from the inactive position to the deployed position based on rotational speed of the respective wheel;
an inner annular portion on the proximal side plate shaped to follow a path followed by the magnetic assemblies when arranged in the inactive position, wherein the inner annular portion is arranged such that substantially no eddy currents are induced therein; and
an outer annular portion on the proximal side plate shaped to follow a path followed by the magnetic assemblies when arranged in the deployed position, wherein the outer annular portion is non-ferrous and electrically conductive such that eddy currents are inducible therein for opposing rotation of the respective wheel for braking thereof.

In one arrangement, the magnetic assemblies are slidably movable between the inactive and deployed positions radially of the at least one wheel.

In one arrangement, the inner annular portion has a larger radial spacing between inner and outer edges than a radial spacing of the outer annular portion between inner and outer edges thereof.

In one arrangement, the magnetic assemblies are carried on a support disc connected in fixed rotational relation to a respective one of the at least one wheel, wherein the magnetic assemblies are respectively slidably supported in slots in the support disc, wherein each of the magnetic assemblies comprises a magnetic device configured to generate a respective magnetic field of the magnetic assembly and a counterweight with substantially the same mass as the magnetic device, and wherein the magnetic device and counterweight are supported for sliding movement relative to the disc on opposite sides thereof.

Preferably, the magnetic assemblies are respectively biased to the inactive position by biasing members received in the slots. This may provide modulated or gradual deployment of the magnetic assemblies for braking to produce different degrees of braking (torque).

In one arrangement, the biasing members are compression springs respectively configured to resist movement of opposite ends thereof along a spring axis.

In one arrangement, the inner annular portion is integral with the proximal side plate.

In one arrangement, the outer annular portion is distinct from the proximal side plate and supported in a recess therein.

In one arrangement, the trolley further includes a cooling system thermally coupled to the outer annular portion to receive heat generated by the induced eddy currents.

In one such arrangement, the proximal side plate comprises one or more openings registered with the outer annular portion so that the cooling system is passed through the one or more openings in the proximal side plate to an exterior of the housing.

In one arrangement, the inner and outer annular portions are both electrically conductive but made from different materials.

The cooling system may have any of the earlier mentioned features.

According to yet another aspect of the invention there is provided a trolley for movement along a tensioned support member spanning from a first location to a second location, the trolley comprising:
a pair of upstanding side plates supported in generally-parallel laterally spaced-apart relation;
wherein the side plates are made of non-ferrous electrically conductive material;
wherein the side plates are arranged to receive the tensioned support member therebetween;
at least one wheel between the side plates and configured for rolling engagement with the tensioned support member;
a plurality of magnetic devices configured for generating a magnetic field;
wherein the magnetic devices are supported on a respective one of the at least one wheel at angularly spaced positions about a wheel axis thereof so as to rotate with the respective wheel;
wherein the magnetic devices are movable relative to the respective wheel from an inactive position in which substantially no eddy currents are induced in a proximal one of the side plates to a deployed position in which eddy currents are induced in the proximal side plate for opposing rotation of the respective wheel;
wherein the magnetic assemblies are configured to move from the inactive position to the deployed position based on a rotational speed of the respective wheel in order to brake the respective wheel; and
a cooling device thermally coupled to the proximal side plate to receive heat generated by the induced eddy currents;
wherein the cooling device is configured for releasing the received heat to ambient air as the trolley moves along the tensioned support member.

In one arrangement, the cooling device projects from the proximal side plate.

In one arrangement, the passive heat exchanger members are arranged on an exterior face of the proximal side plate opposite to the at least one wheel.

In addition or alternatively thereto, the passive heat exchanger members may be arranged on an interior face of the proximal side plate adjacent to the at least one wheel.

In one arrangement, the passive heat exchanger members comprise fins projecting from the face of the proximal side plate and made from thermally conductive material.

In one such arrangement, the fins extend longitudinally of the proximal side plate substantially the full length thereof.

In another arrangement, the passive heat exchanger members comprise thermally conductive bodies each defining an enclosed interior cavity containing a phase-change fluid, each thermally conductive body having a base portion in thermal contact with the proximal side plate and a free portion arranged in thermal contact with the ambient air, such that the phase-change fluid is enabled to receive heat from the proximal side plate at the base portion of the thermally conductive body and to release the heat at the free portion.

In one such arrangement, the thermally conductive bodies are arranged in a grid-like array on the face of the proximal side plate.

Any of the above features may be combined.

### BRIEF DESCRIPTION OF THE DRAWINGS

The invention will now be described in conjunction with the accompanying drawings in which:

FIG. 1 is a top perspective view of a first arrangement of trolley according to the present invention;

FIG. 2 is a bottom perspective view of the arrangement of FIG. 1;

FIG. 3 is a bottom view of the arrangement of FIG. 1;

FIG. 4 is a cross-sectional view along line 4-4 in FIG. 3 showing magnetic assemblies of a braking system thereof in an inactive position;

FIG. 5 is a perspective view of a portion of the trolley showing a side plate and an eddy current-carrying portion;

FIG. 6 is a cross-sectional view like FIG. 4 but showing the magnetic assemblies in a deployed position;

FIG. 7 is a cross-sectional view of the arrangement of FIG. 1 as if it were taken along line 7-7 in FIG. 6;

FIG. 8 is a perspective view from one side of a portion of a braking system of the arrangement of FIG. 1, where the magnetic assemblies are in an inactive position;

FIG. 9 is a perspective view from an opposite side of the portion of the braking system in FIG. 8;

FIG. 10 is a partial cross-sectional view along a diameter the portion of FIGS. 8 and 9;

FIG. 11 is a leading end view of the arrangement of FIG. 1;

FIG. 12 is a trailing end view of the arrangement of FIG. 1;

FIG. 13 is a perspective view of the portion of the trolley shown in FIG. 6 but from an outer side thereof;

FIG. 14 is a side view of the arrangement of FIG. 1;

FIGS. 15 and 16 are top and bottom perspective views of another arrangement of trolley according to the invention; and

FIGS. 17 and 18 are top and bottom perspective views of yet another arrangement of trolley according to the present invention.

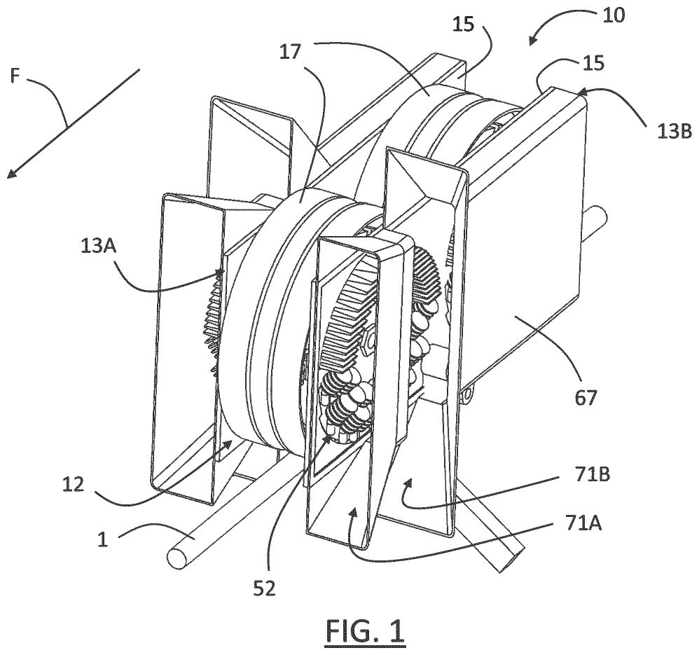

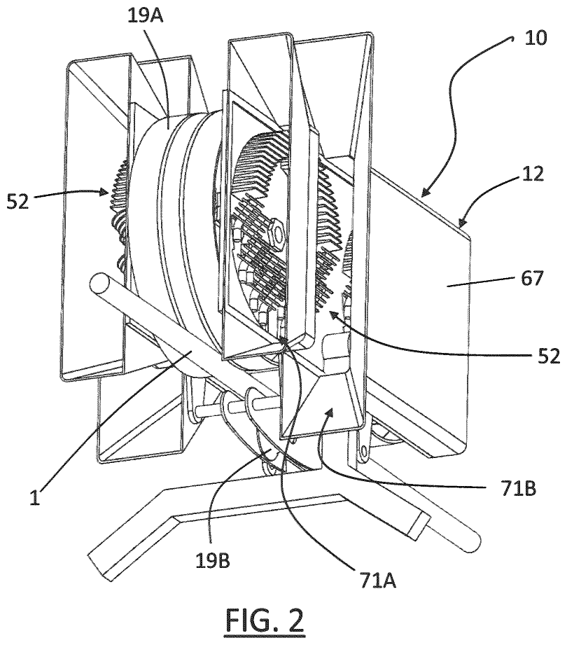

In the drawings like characters of reference indicate corresponding parts in the different figures.

### DETAILED DESCRIPTION

Generally speaking, a zip line trolley 10 for movement along a tensioned support member 1 spanning from a first location to a second location, such as a tensioned cable spanning between a pair of spaced-apart towers, comprises a housing 12 having a leading end 13A arranged to face forwardly, in a forward direction of travel F, and a longitudinally opposite trailing end 13B and configured to receive the tensioned support member 1 therethrough. The tensioned support member 1 extends longitudinally through the housing 12. Furthermore, the housing 12 comprises a pair of upstanding side plates 15 supported in generally-parallel laterally spaced-apart relation and arranged on either side of the tensioned support member 1, and the side plates are metallic, meaning that they are made of metallic material, which may or may not be ferrous and which may or may not be electrically conductive. The side plates 15 are supported in generally-parallel, upstanding and laterally spaced-apart relation to one another by fasteners so as to receive the cable therebetween.

Furthermore, the trolley 10 comprises at least one wheel 17 supported by the housing 12 between the side plates 15. The at least one wheel 17 is configured for rolling engagement with the tensioned support member 1 and is rotatable around a wheel axis 18 which is laterally oriented, such that each of the at least one wheel is rotatable in an upstanding plane. Typically, the at least one wheel comprises two longitudinally-spaced carrier wheels 19A arranged for rolling engagement with an upper side of the tensioned support member 1, so as to carry a load of the trolley arranged under the support member 1, and one upstop wheel 19B arranged for rolling engagement with an underside of the tensioned member 1. The plurality of wheels 19A and 19B form a pathway or passageway for the tensioned support member 1 through the housing 12, to which the tensioned support member 1 is confined. Furthermore, all of the wheels are freewheeling, that is they are passive or not driven for example by a motor, and such that the trolley moves along the cable due to gravity, the speed and acceleration of its movement being dependent on the weight of the rider and angle of declination of the cable and various other factors.

To slow rotation of the at least one wheel to brake and eventually stop the trolley, the trolley 10 includes a braking system mounted to the at least one wheel 17 and configured to induce eddy currents that act to oppose rotation of the at least one wheel.

The braking system generally comprises a plurality of magnetic devices 24 respectively configured to generate magnetic fields. The magnetic devices 24 are supported on a respective one of the at least one wheel, in this case carrier type wheel 19A, to rotate around the wheel axis 18 therewith. In other words, the magnetic devices 24 are supported in fixed rotational relation with the respective wheel, so that they rotate with the wheel. The magnetic devices 24 are disposed on the respective wheel in proximity to a proximal one of the side plates 15 such that the magnetic fields of the magnetic assemblies passes through the proximal side plate. In the illustrated arrangement, this is the side of the wheel facing laterally outwardly towards the proximal side plate 15. In other words, the magnetic devices 24 are operatively mounted on a laterally outward side of the wheel relative to the tensioned support member 1.

In the illustrated arrangements, all of the carrier wheels 19A include the magnetic devices 24.

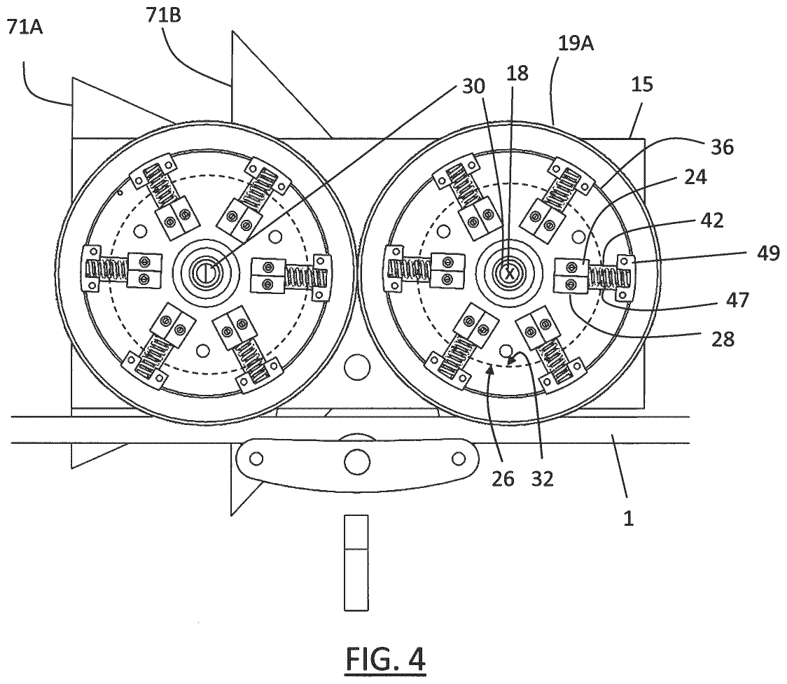

Also, in the illustrated arrangements, and as more clearly shown in FIG. 4, the magnetic devices 24 are arranged at angularly spaced positions about the wheel axis 18 of the respective wheel to which they are mounted, and the magnets are displaced along circular paths when the carrier wheel (on which the magnets are received) rotates.

To cooperate with the magnetic devices 24 for braking, there is provided an eddy current-carrying portion 26 on the proximal side plate 15, which is non-ferrous and electrically conductive. The eddy current-carrying portion 26 is in fixed relation with a remainder of the side plate, so as to be stationary relative to the magnet-carrying wheel. As such, when the magnets move relative thereto, eddy currents are generated in this portion.

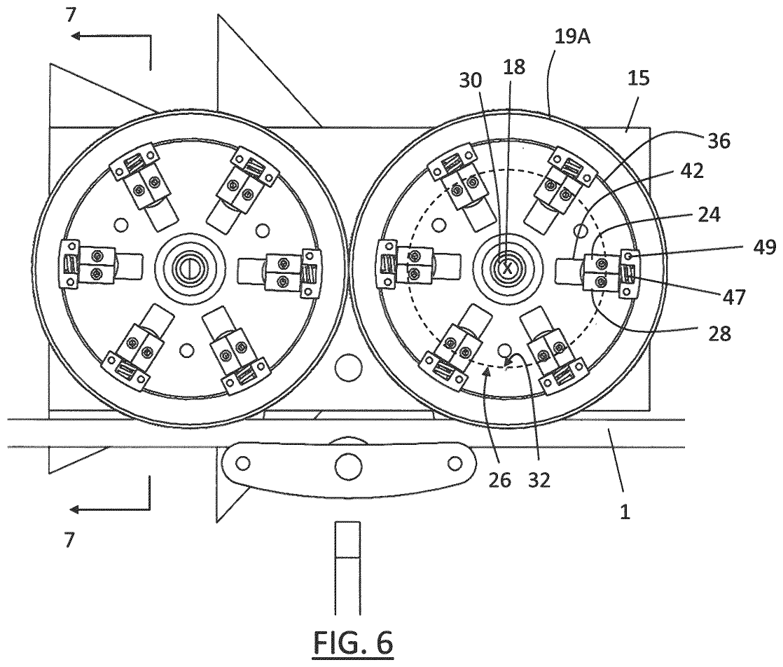

Referring back to FIG. 4, the magnetic devices 24 are movable relative to the respective wheel 19A between an inactive position, as shown in FIG. 4, in which substantially no eddy currents are induced in the eddy current-carrying portion, and a deployed position, as shown in FIG. 6, in which eddy currents are inducible in the eddy current-carrying portion 26 for opposing rotation of the respective wheel for braking thereof. Typically, this movement is outward relative to the wheel axis 18 of the wheel on which the magnetic devices 24 are operatively mounted. Also, the magnetic devices 24 are movable relative to the mounting carrier wheel 19A, that is the respective wheel on which they are carried, in a plane parallel to the rotational plane of the wheel.

The magnetic devices 24 are configured to move from the inactive position to the deployed position based on rotational speed of the respective wheel. More specifically, movement from the inactive position to the deployed position is based on change in rotational speed. As the rotational speed increases, the magnetic devices move radially outwardly. Correspondingly, eddy currents increase in magnitude, which is directly proportional to braking force applied on the wheel carrying the magnetic devices.

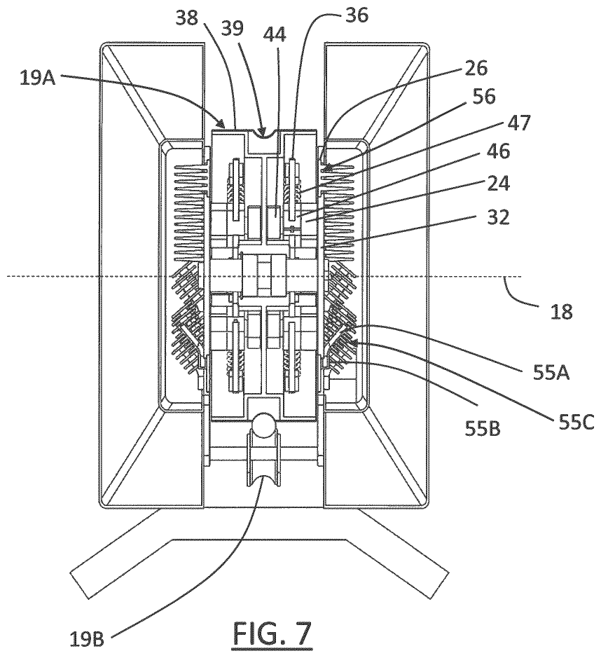

With reference to FIG. 7, in the illustrated arrangements there are provided sets of magnetic devices 24 and respectively cooperating eddy current-carrying portions on both sides of the trolley. As such, both side plates 15 act as ‘proximal side plates’ with respect to a set of the magnetic devices located on a corresponding side of the trolley.

To effect movement between the non-braking and braking positions relative to the wheel, each one of the magnetic devices 24 forms a respective magnetic assembly 28, for generating a respective magnetic field, which is slidably movable relative to the respective wheel between the inactive position, in which the magnetic assemblies are located at inwardly spaced locations from a circumference of the respective wheel, and the deployed position in which the magnetic assemblies are located radially outward from the inactive position. That is, the magnetic assemblies are configured for sliding movement within a rotational plane of the respective wheel between the inactive and deployed positions, between which there is spacing generally in a radial direction of the wheel. In the deployed position, the magnetic assemblies are located at the circumference of the respective wheel. In the inactive position, the magnetic assemblies 28 are closer to a shaft 30 defining the wheel axis 18 of the respective wheel than to the circumference of the wheel, and in the deployed position, the assemblies 28 are located closer to the circumference than to the shaft.

To minimize or avoid braking action in the inactive position, even if the magnetic assemblies are generating their magnetic fields in the inactive position, for example when the magnetic devices comprise permanent magnets, there is provided an inner annular portion 32 on the proximal side plate, in opposite relation to the magnetic assemblies on a proximal side of the wheel 17, which is shaped to follow or register with a path followed by the magnetic assemblies when arranged in the inactive position. The inner annular portion is arranged, for example by spacing in the lateral direction from the magnetic devices, such that substantially no eddy currents are induced therein. The inner annular portion is represented schematically as an area between the shaft and a circular stippled line in FIGS. 4 and 6, which is indicated at 32.

Furthermore, the trolley 10 includes an outer annular portion on the proximal side plate, defining the eddy current-carrying portion 26, which is shaped to follow or register with a path followed by the magnetic assemblies when arranged in the deployed position. The outer annular portion is non-ferrous and electrically conductive such that eddy currents are inducible therein to oppose rotation of the respective wheel for braking thereof. The outer annular portion is represented by an area between the circular stippled line in FIGS. 4 and 6 and a circumference of element 36 to be introduced shortly.

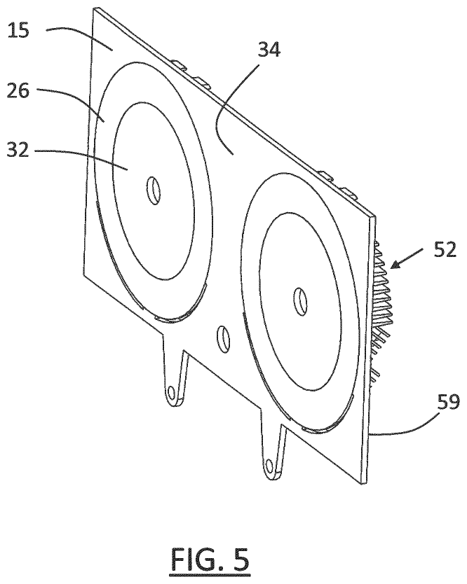

In the first illustrated arrangement, and with reference to FIG. 5, both the inner and outer annular portions 32, 26 are circular disc-shaped. However, the inner annular portion 32 has a larger radial spacing between inner and outer sides thereof, delimiting the annulus, than the outer annular portion 26, so as to limit a range of rotational speeds, towards an upper range defining an upper limit of possible rotational speeds, over which the trolley 10 experiences braking action.

The inner annular portion 32 of the illustrated arrangement is integral with the proximal side plate 15 so as to be made of the same material. Since the side plates 15 are structural components providing structural strength to the trolley 10, they are typically made from metallic material, which is usually electrically conductive. As such, the inner annular portion 32 may also be conductive, so, when the side plate with integral inner annular portion is made from a planar sheet of metallic material, the inner annular portion 32 may be recessed from an interior face of the side plate by reducing at this location a thickness of the side plate, such that there is a greater lateral spacing of the inner annular portion from the magnetic assemblies located in a common longitudinally-extending rotational plane. Furthermore, when the inner annular portion 32 is integrally formed with the side plate, the inner edge thereof receives the shaft 30 of a corresponding one of the carrier wheels 19A.

Conversely, in the first illustrated arrangement, the outer annular portion 26 is distinct from the proximal side plate 15 and supported in a recess therein. Thus the outer annular portions 26 act as inserts relative to the corresponding side plate receiving same. The recess is formed on an interior side 34 of the plate 15 and encompasses the inner annular portion 32. The outer annular portion is made from, for example, copper, while the proximal side plate 15 is made from, for example, stainless steel or aluminum, which are electrically conductive. Even when both the outer annular portion and the side plate are electrically conductive and in physical contact with one another, eddy currents are substantially not transmitted, in other words they do not flow, from the outer annular portion to the side plate because they are not integral. This effect may be further emphasized by use of different materials.

As such, the eddy current braking system induces increasing amounts of electrical current in a non-ferrous, electrically conductive component in proximity to the magnetic devices, so that the magnetic fields thereof pass through this component, which acts to increasingly resist the rotary motion of the magnets, thus creating the brake torque on the wheels which slows the speed of the trolley on the tensioned support member.

A major effect of the eddy current braking is electrical resistance heating in current-carrying component. This heat generation can be so large as to cause component failure.

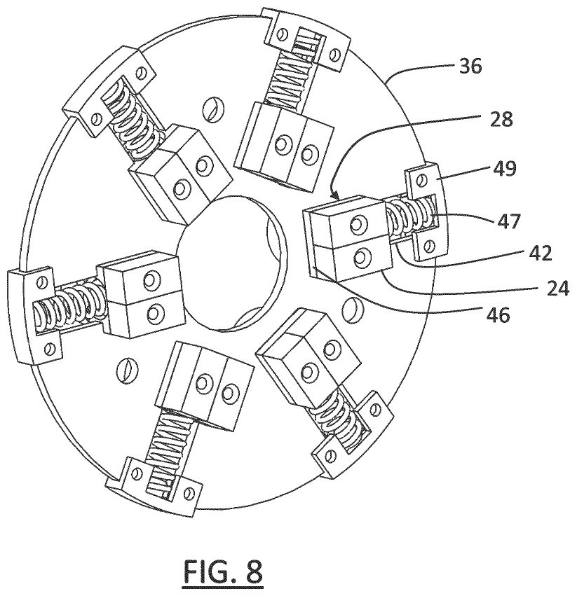

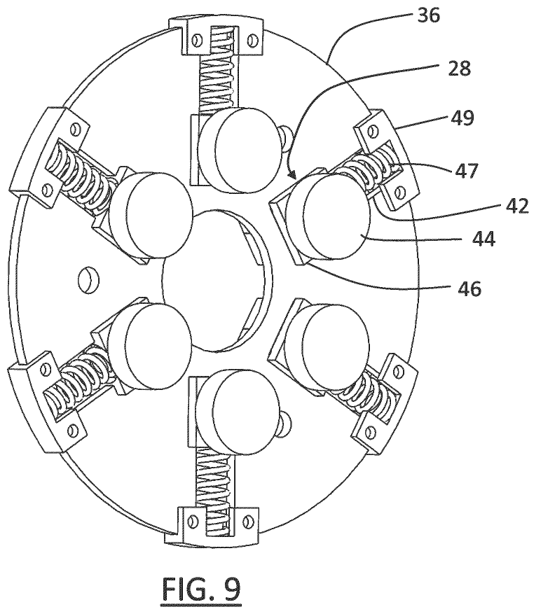

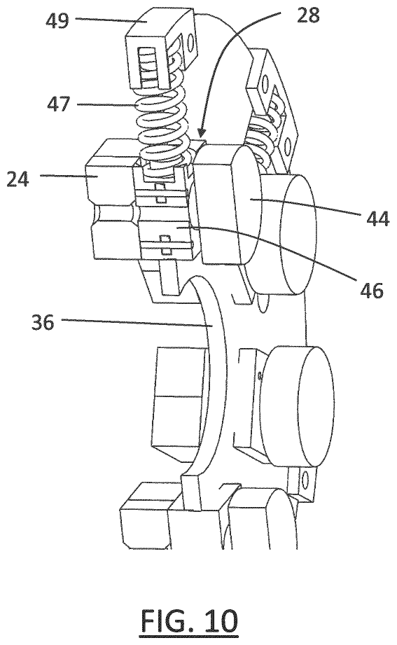

Turning back now to the magnetic assemblies 28 and with reference to FIGS. 4, 6 and 8-10, the assemblies 28 of the first illustrated arrangement are slidably movable between the inactive and deployed positions radially of the respective carrier wheel 19A. In other words, movement between the inactive and deployed positions is substantially in a radial direction of the wheel. As such, start and end points of the movement between positions basically lie along a radius of the respective wheel. More specifically, in this arrangement, the movement between these positions for each magnetic assembly occurs in a linear path.

In the first illustrated arrangement, and as shown in FIGS. 7-10, the magnetic assemblies 28 are carried on a support disc 36 connected in fixed rotational relation to the respective carrier wheel 19A. This support disc 36 is an interior component so as to be disposed inside the wheel, which has an outer shell 38 supporting a circumferential groove 39 which receives the tensioned support member 1.

The magnetic assemblies 28 are respectively slidably supported in slots 42 in the support disc 36. In addition to the magnetic device 24, each magnetic assembly 28 comprises a counterweight 44 with substantially the same mass as the magnetic device 24 and supported for sliding movement relative to the disc on an opposite side of the disc to the device 24. The counterweight 44 is carried on a side of the disc 36 which is distal to the closest side plate. In each assembly, the magnetic device 24 and counterweight 44 are interconnected by a slidable base 46 which is slidably mated with the slot 42 in the disc 36.

To control a rotational speed at which the magnetic assemblies 28 move from the inactive position to the deployed position, the magnetic assemblies are respectively biased to the inactive position by biasing members 47 received in the slots 42. This may provide modulated or gradual deployment of the magnetic assemblies for braking to produce different degrees of braking (torque). In the first illustrated arrangement, the biasing members 47 are conventional compression springs respectively configured to resist movement of opposite ends thereof towards each other along a spring axis. The biasing members 47 are respectively connected at first ends to the respective magnetic assembly 28 and at opposite second ends in fixed relation to the disc 36 by a cap 49 which closes the slot 42 which is otherwise open at the wheel circumference. The biasing members 47 are linear and respectively coaxial with the slots 42 in which they are received.

Upon braking, the induced eddy currents in the outer annular, eddy current-carrying portion 26 generate heat, and as such the trolley 10 includes a cooling system 52 thermally coupled thereto to receive this heat and configured to release the same to ambient air as the trolley moves along the tensioned support member 1. Basically, the cooling system 52 is a heat exchanger operating between the eddy current-carrying portions 26 of the trolley 10 and to the air, so as to transfer heat therebetween.

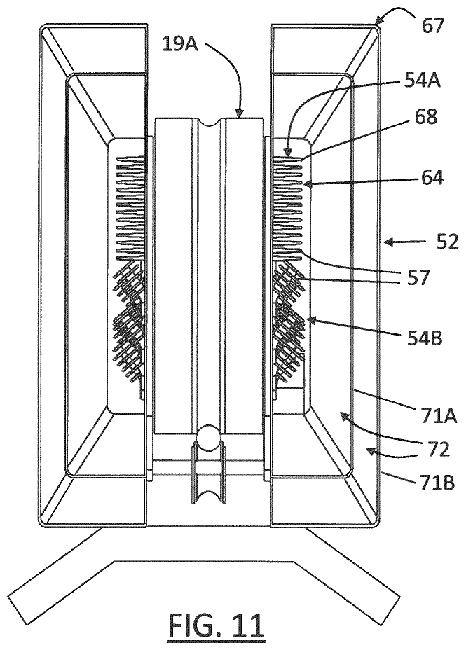

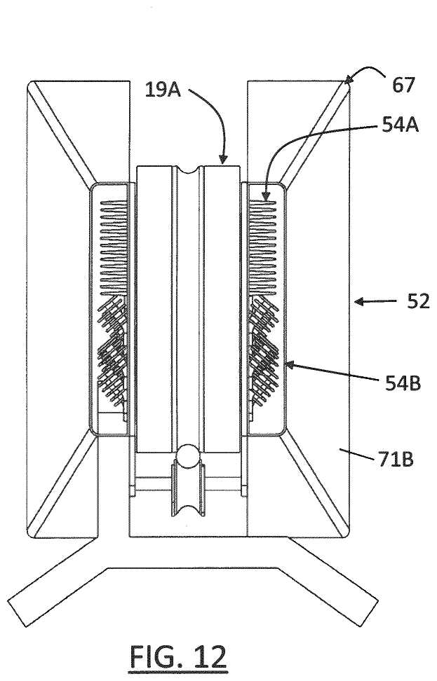

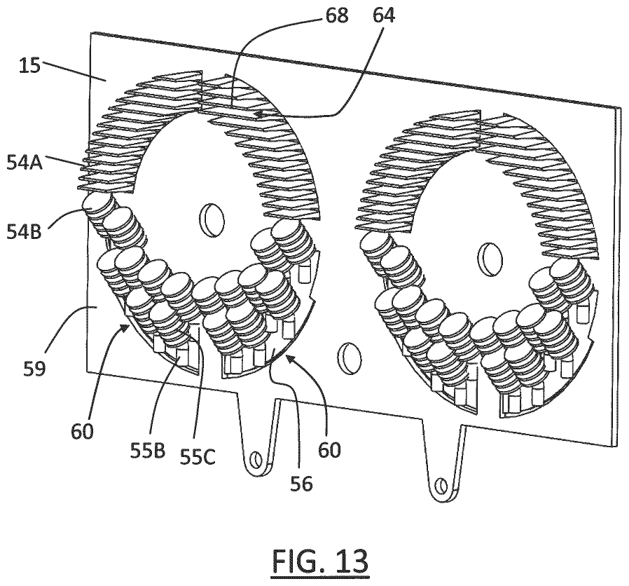

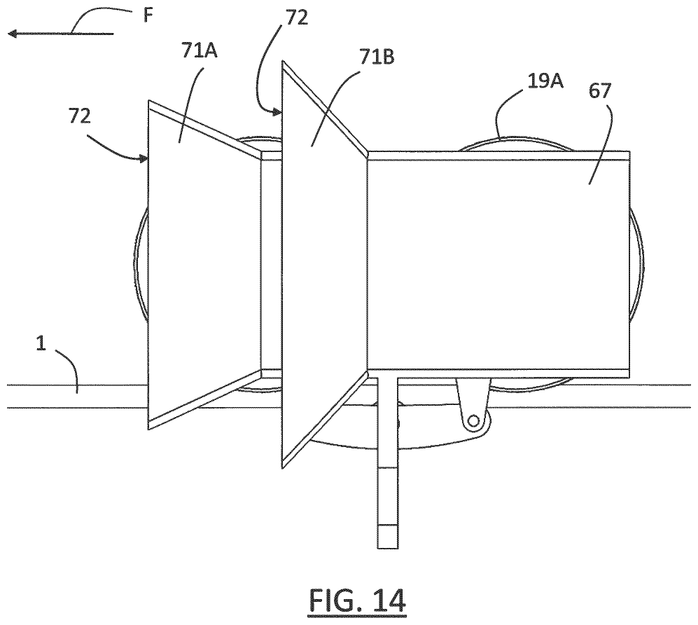

With reference to FIGS. 7 and 11-13, in the illustrated arrangements, the cooling system 52 comprises a plurality of passive heat exchanger members 54A and 54B arranged on a face 56 of each eddy current-carrying portion 26. The heat exchanger members 54 are passive in that they operate absent any power input from a source. In other arrangements, the cooling system may be active and include, for example, a driven liquid-cooling heat exchanger system.

To maximize cooling effect, the passive heat exchanger members 54A, 54B have exterior surfaces 57 arranged to be exposed to the ambient air, and a total surface area of the exterior surfaces of the passive heat exchanger members is greater than a surface area of the face 56 of the eddy current-carrying portion.

The passive heat exchanger members 54 are arranged on a face 56 of the eddy current-carrying portion opposite to the corresponding carrier wheel. This face 56 is exposed to an exterior side 59 of the side plate 15 by one or more openings 60 registered with the eddy current-carrying portion 26 so that the cooling system passes therethrough to an exterior of the housing.

In the illustrated arrangements, the passive heat exchanger members 54 comprise at least one of (i) fins 54A projecting from the face of the eddy current-carrying portion 26 and made from thermally conductive material, and (ii) thermally conductive bodies 54B, such as conventional heat pipes, which are more clearly shown in FIG. 7. The bodies 54B each define an enclosed interior cavity 55A containing a phase-change fluid, with a base portion 55B of the body in thermal contact with the eddy current-carrying portion 26 and a free portion 55C arranged in thermal contact with the ambient air, such that the phase-change fluid is enabled to receive heat from the eddy current-carrying portion at the base portion of the thermally conductive body and to release the heat at the free portion. The free portion 55C projects from the base portion 55A and is substantially surrounded by air. The free portion 55C includes a plurality of discs to increase an exterior surface area thereof.

The fins 54A may be integrally formed with the outer annular portion 26.

In the case of the fins, they extend longitudinally of the housing 12, typically respectively along a linear path on the face of the eddy current-carrying portion, and they are arranged in side-by-side relation on the face of the eddy current-carrying portion. Furthermore, each fins 54A, at its location on the face 56 of the outer annular portion, extends a full distance between longitudinally opposite edges on the outer annular portion 26.

In the illustrated arrangements, the fins 54A are arranged on the face 56 of the eddy current-carrying portion so that each adjacent pair of the fins forms a longitudinally extending duct 64.

To assist in guiding or directing ambient air through the ducts 64, the trolley 10 includes at least one longitudinally-extending covering member 67 spanning between free tips 68 of the fins to close the ducts. Since the braking system is provided on both sides of the housing, there are two covering members, one for each side.

Each covering member 67 forms at least one air-scoop, such as 71A, delimiting an inlet opening 72 outwardly of the free tips 68 of the fins. Thus, ambient air from areas outward of the heat exchanger members is guided over same.

To maximize cooling effect, a plurality of the air-scoops 71A and 71 B may be provided, each delimiting an inlet opening outwardly of the free tips of the fins. The multiple air-scoops 71A, 71B are located at longitudinally spaced positions so as to provide a leading one of the air-scoops at a front end of the proximal side plate and at least one trailing air-scoop rearwardly thereof, and the inlet opening of said at least one trailing air-scoop being larger than the inlet opening of the leading one of the air-scoops.

In the case of the phase change fluid-containing thermally conductive bodies 54B, such as heat pipes, the covering member 67 forms a duct member supported adjacent the thermally conductive bodies, which is in the form of an air-scoop delimiting an inlet opening outwardly of the passive heat exchanger members.

In typical use, the trolley with freewheeling wheels 17 is under uncontrolled acceleration based on a weight of a load suspended from the trolley (i.e. a rider), providing an acceleration force due to gravity, and an angle of declination of the tensioned support member.

In use, when the trolley 10 is in translational motion, typically in the forward direction of travel F along the tensioned support member 1, magnetic devices 24, which are configured to generate magnetic fields, are caused to move relative to a housing 12 of the trolley containing wheels 17 amongst other components of the trolley. When the magnetic devices are mounted on a respective one of the wheels, this movement is in effect a revolution about an axis 18 of the wheel.

Upon revolution around the wheel axis, the magnetic devices 24 induce eddy currents in non-ferrous electrically conductive component located in proximity to the magnetic devices such that the magnetic fields thereof pass through the component. Generation of the eddy currents acts to resist or oppose the motion of the magnets, which in turn resists rotation of the wheel on which they are mounted (and which is effecting their motion).

The non-ferrous electrically conductive component is shaped to register with a revolutionary path traversed by the magnetic devices 24 in revolution around the wheel axis 18. Preferably, this path is that of an outermost position of the magnetic devices from the wheel axis 18.

The path of the outermost position of the magnetic devices therefore corresponds to a maximum braking force which may be generated for application to the wheel.

As the magnetic devices approach the outermost position from the wheel axis, based on rotational speed of the wheel, an increasing magnitude of eddy currents are induced in the eddy current-carrying component which creates a braking force of proportional magnitude.

This arrangement provides a manner of disposing of heat generated by induced eddy currents so that the trolley with eddy current brake system can be used in applications where prolonged or more aggressive braking of the trolley is needed, such as on steep slopes.

### Embodiment 2: Heat Sinks with Ducted Air Cooling

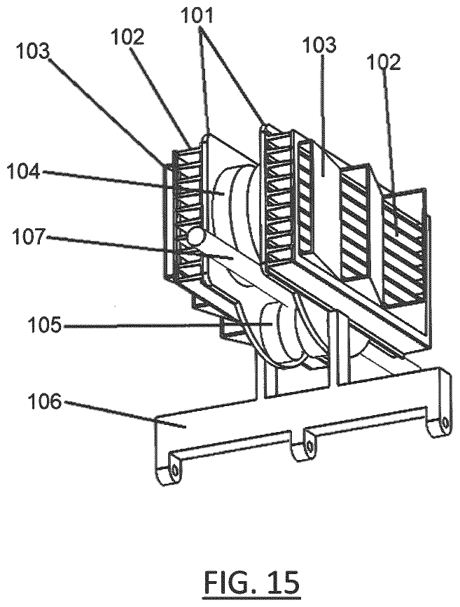

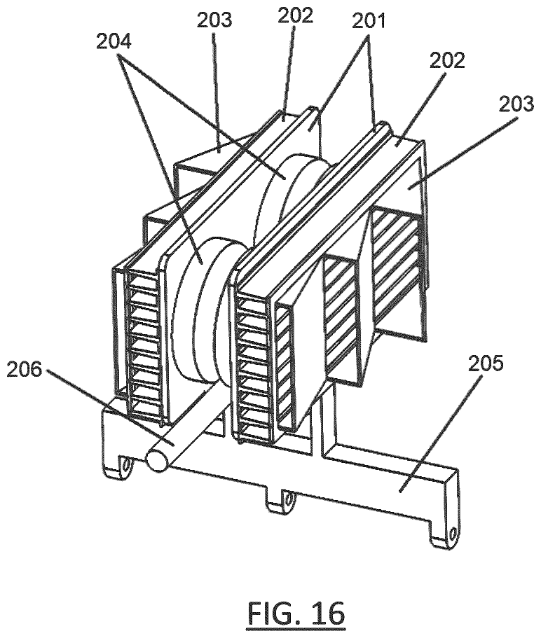

FIGS. 15 and 16 show the following components: side plates 101 of electrically conductive non-ferrous metal which are the frame of the trolley and also the plates within which eddy currents are generated as a result of close proximity of the magnets, passive finned heat sinks 102 of copper or aluminum (that is, a non-ferrous thermally conductive metallic material), cover 103 over heat sinks with integrated ducting features to force the maximum amount of air over the heat sinks, trolley wheels 104 that ride on top of the cable and allow the trolley to roll down the cable. The wheels 104 are fixed axially between the side plates 101 but are free to rotate about their own individual wheel axes, upstop wheel 105 to keep the trolley from moving upward off of the cable. The upstop wheel 105 is also fixed axially between the two plates but is free to rotate, spreader beam 106 that the rider attaches their body harness to and connects the rider to the trolley, a tensioned support member in the form of a cable 107 that the trolley rides on, spanning from a first higher point to a second lower point in the zip line course.

In regard to finned heat sink passive air cooling, there are provided aluminum or copper finned heat sinks having parallel fins protruding perpendicular to their base and parallel to each other and longitudinally oriented 102 could be attached to the outside or inside of the two parallel electrically conductive (at bases of the fins which are generally T-shaped), non-ferrous metal side plates 101 which are spaced apart an appropriate distance. The function of the heat sink 102 is to draw heat out of side plates 101 when the eddy current brake system is active. There could then be ducting 103 on the outward side of and around the heat sinks 102 arranged open to the front/top/bottom to force the maximum amount of air over the heat sinks when the trolley is rolling down the tensioned cable 107. The finned heat sink 102 and outer duct cover 103 arrangement would be utilized on both sides of the trolley in a mirrored orientation. The connection between the finned heat sink 102 and the conductive non-ferrous metal side plates 101 can be optimized in various ways including the utilization of thermal paste or the side plates could be made from the base the finned heat sinks themselves. There can be many arrangements of finned heat sinks 102. Upstop wheel 105 located below the cable 107 and riding near the bottom of the cable 107 prevents the trolley from moving upward and off of the cable 107. The spreader beam 106 is a transverse member hanging below the trolley that the rider attaches their body harness to, thereby connecting the rider to the trolley.

As shown in FIGS. 15 and 16, the fins extend longitudinally of the proximal side plate along a linear path substantially the full length of the side plate. The fins are arranged in side-by-side relation on the exterior face of the proximal side plate so that each adjacent pair of the fins forms a longitudinally extending duct on the exterior face of the proximal side plate. Each duct is open at a front end and at a rear end of the side plate for receiving and releasing the ambient air in movement of the trolley along the cable.

As shown in FIGS. 15 and 16, there is provided at least one longitudinally-extending covering member in the form of outer duct cover 103 spanning between free tips of the fins, which are distal to the bases of the fins, to close the ducts formed by the fins. This cover acts to guide the ambient air along the full length of the duct. The cover also forms at least one air-scoop delimiting an inlet opening outwardly of the free tips of the fins to capture ambient air beyond the free tips of the fins so as to increase the air flow along the ducts between the fins. Preferably there are a plurality of the air-scoops at longitudinally spaced positions so as to provide a leading one of the air-scoops at a front end of the proximal side plate and at least one trailing air-scoop rearwardly thereof, and the inlet opening of the trailing air-scoops are larger than the inlet opening of the leading one of the air-scoops and even relative to the trailing air scoops each such air-scoop located closer towards the rear end of the side plate has a larger inlet opening than the air-scoops in front of same.

On each side of each wheel 104 and mounted to the wheels is a set of magnets (not shown) that rotate with the wheel. The magnets can be moved either radially or axially in order to bring them near to the side plates 101. The magnets are moved by centrifugal force of either the magnets themselves of other components arranged in a suitable way and the magnet position is dependent upon the wheel speed. One version of that magnetically induced eddy current braking system is covered in U.S. Pat. No. 10,065,507. When the eddy current braking system is activated it creates electrical current in the side plates 101 which slows the motion of the magnets to create the brake torque on the wheels which slows the speed of the trolley on the cable.

### Embodiment 3: Heat Pipe Module Cooling of Trolley Side Plates

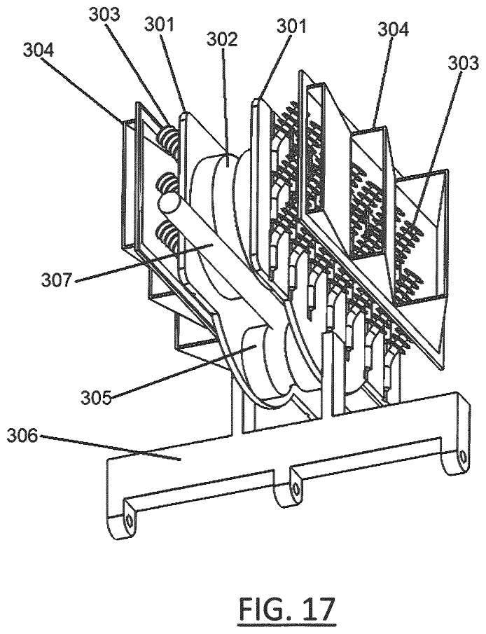

Components shown in FIG. 17 are: 301 side plates of electrically conductive non-ferrous metal which are the frame of the trolley and also the plates within which eddy currents are generated as a result of close proximity of the magnets, 302 load carrying trolley wheels that ride on top of the cable and allow the trolley to roll down the cable. The wheels 302 are fixed axially between the side plates 301 but are free to rotate., 303 heat pipe/vapor chamber module assembly or arrangement of individual heat pipes or vapor chambers for transferring heat between the side plates 301 and ambient air, 304 cover over heat pipes with integrated ducting features to force the maximum amount of air over the heat pipes, 305 upstop wheel to keep the trolley from moving upward off of the cable, 306 spreader beam, attached to trolley, that the rider attaches their body harness to, 307 cable, suspended from the top to the bottom of the zip line course, which the trolley rides on.

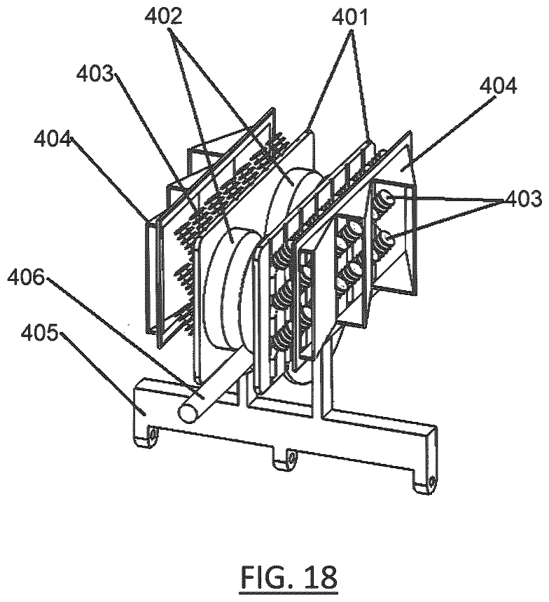

Components shown in FIG. 18 are: 401 side plates of electrically conductive non-20 ferrous metal which are the frame of the trolley and also the plates within which eddy currents are generated as a result of close proximity of the magnets, 403 heat pipe/vapor chamber module assembly for transferring heat between the side plates 401 and ambient air, 404 cover over heat pipes with integrated ducting features to force the maximum amount of air over the heat pipes, 405 spreader beam, attached to trolley, that the rider attaches their body harness to and 406 cable, suspended from the top to the bottom of the zip line course, which the trolley rides on.

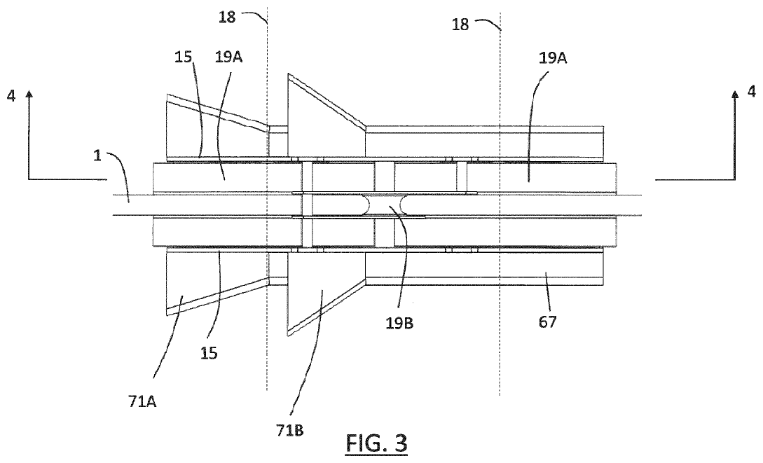

The third embodiment of the thermal cooling system for the trolley is to use heat pipes or vapor chambers to draw heat away from the plates which contain the heat generated by the eddy currents and transfer the heat to the ambient air. In this configuration the electrically conductive, non-ferrous side plates 301 that are parallel, aligned and spaced apart an appropriate distance, would have integrated or separately attached heat pipe or vapor chamber cooling module or individual heat pipes or vapor chambers 303, integrated onto the exterior surface in some suitable arrangement such as a grid-like array as shown in FIGS. 3 and 4. The side plates 301 could also be integral with the heat pipe/vapor chamber cooling module. The load carrying wheels 302 are mounted between the side plates 301 at the same level and fixed axially but free to rotate about their own axes. Ducted covers 304 around the heat pipe system would direct ambient air over the heat pipe system so that that the air will remove as much of the heat generated by the trolley brakes from the heat pipes as possible. The heat pipes/vapor chambers 303 could be arranged in any suitable manner. These covers 304 are substantially the same in configuration as those described in relation to the first illustrated embodiment. One arrangement of the embodiment implementing heat pipes/vapor chambers is shown for illustrative purposes. Upstop wheel 305 located below the cable 307 and riding near the bottom of the cable 307 prevents the trolley from moving upward and off of the cable 307. The spreader beam 306 is a transverse member hanging below the trolley that the rider attaches their body harness to, thereby connecting the rider to the trolley.

The heat pipes or vapor chambers are conventional arrangements of passive heat exchangers comprising thermally conductive bodies each defining an enclosed interior cavity containing a phase-change fluid, each thermally conductive body having a base portion in thermal contact with the proximal side plate and a free portion arranged in thermal contact with the ambient air and free from thermal contact with the side plate (i.e., spaced therefrom). Thus the phase-change fluid is enabled to receive heat from the proximal side plate at the base portion of the thermally conductive body and to release the heat at the free portion. The phase-change fluid typically gravitationally resides in the base portion in liquid state, where it is positioned to receive or absorbs heat from the side plate until the phase-change fluid changes from the liquid to the gaseous state, and accordingly rises to the free portion of the heat pipe/vapor chamber that is located. The interior cavity has a lower portion at the base portion of the thermally conductive body to gravitationally collect the phase-change fluid in the liquid state, and an upper portion at the free portion of the thermally conductive body disposed at a higher elevation than the lower portion of the cavity to collect the phase-change fluid in the gaseous state as it expands and rises.

On each side of each wheel 302 and mounted to the wheels is a set of magnets (not shown) that rotate with the wheel. The magnets can be moved either radially or axially in order to bring them near to the side plates 301. The magnets are moved by centrifugal force of either the magnets themselves of other components arranged in a suitable way and the magnet position is dependent upon the wheel speed. One version of that magnetically induced eddy current braking system is covered in U.S. Pat. No. 10,065,507. When the eddy current braking system is activated it creates electrical current in the side plates 301 which slows the motion of the magnets to create the brake torque on the wheels which slows the speed of the trolley on the cable.

Thus according to the present invention there is provided a cooling device, such as one or more of devices 102 or 303, thermally coupled to the proximal side plate 101 to receive heat generated by the induced eddy currents, and which is configured to release the received heat to ambient air as the trolley 10 moves along the cable. Thus is provided a manner to dispose of that heat so that the eddy current brake system can be used on more steep slopes than it could without these solutions.

Typically, the cooling device comprises a plurality of such devices arranged on the proximal side plate 101 to increase a rate of heat dissipation.

The cooling device 102 or 303 projects from the proximal side plate 101 in which the eddy currents are induced when the magnets are in the deployed position.

The cooling device comprises a plurality of passive heat exchanger members 101 or 303 arranged on a face of the proximal side plate 101. The passive heat exchanger members have exterior surfaces arranged to be exposed to the ambient air, and a total surface area of the exterior surfaces of the passive heat exchanger members is greater than a surface area of the face of the proximate side plate.

Furthermore, the passive heat exchanger members may be arranged on an exterior face of the proximal side plate opposite to the at least one wheel. Additionally or alternatively, the passive heat exchanger members may be arranged on an interior face of the proximal side plate adjacent to the at least one wheel. When arranged on the interior face, the passive heat exchanger members are connected in the same manner to the side plates as shown and described in relation to connection on the exterior face thereof, except that the passive heat exchanger members are arranged in a manner so as not to interfere with rotation of the at least one wheel between the side plates.

The cooling devices could extend over the top of the trolley and it would make sense to have a ducted cover on top of the trolley as well.

As described hereinbefore, the present invention relates to a zip line trolley for movement along a tensioned support member, such as a cable, with an eddy current braking system including non-ferrous electrically conductive components between which there is rotatably supported at least one wheel rollingly engaged with the cable and carrying magnetic devices which induce eddy currents in the side plates to brake the respective wheel, features a cooling system thermally coupled to the side plate arranged to carry the eddy current, so as to receive heat generated by the induced eddy currents, and configured to release the received heat to ambient air as the trolley moves along the cable. According to another aspect, the braking system features magnetic assemblies supported for generally radially-directed sliding movement on at least one of the wheels and a distinct annular component, which is conducive to carrying eddy currents, and which registered with an outward-most location of the sliding magnetic assemblies.

The scope of the claims should not be limited by the preferred embodiments set forth in the examples but should be given the broadest interpretation consistent with the specification as a whole.

1. A trolley for movement along a tensioned support member spanning from a first location to a second location, the trolley comprising:
a housing having a leading end and longitudinally opposite trailing end and configured to receive the tensioned support member therethrough, wherein the housing comprises a pair of upstanding side plates supported in generally-parallel laterally spaced-apart relation and arranged on either side of the tensioned support member, wherein the side plates are metallic;
at least one wheel supported by the housing between the side plates, wherein the at least one wheel is configured for rolling engagement with the tensioned support member and is rotatable around a wheel axis which is laterally oriented; and
a braking system mounted to the at least one wheel and configured to induce eddy currents that act to oppose rotation of the at least one wheel, wherein the braking system comprises:
a plurality of magnetic devices respectively configured to generate magnetic fields, wherein the magnetic devices are supported on a respective one of the at least one wheel to rotate around the wheel axis therewith, wherein the magnetic devices are disposed in proximity to a proximal one of the side plates such that the magnetic fields of the magnetic devices passes through the proximal side plate;
an eddy current-carrying portion on the proximal side plate, which is non-ferrous and electrically conductive;
wherein the magnetic devices are movable relative to the respective wheel between an inactive position, in which substantially no eddy currents are induced in the eddy current-carrying portion, and a deployed position in which eddy currents are inducible in the eddy current-carrying portion for opposing rotation of the respective wheel for braking thereof;
wherein the magnetic devices are configured to move from the inactive position to the deployed position based on rotational speed of the respective wheel; and
a cooling system thermally coupled to the eddy current-carrying portion to receive heat generated by the induced eddy currents;
wherein the cooling system is configured for releasing the received heat to ambient air as the trolley moves along the tensioned support member.

2. The trolley of claim 1 wherein the cooling system comprises a plurality of passive heat exchanger members arranged on a face of the eddy current-carrying portion, the passive heat exchanger members have exterior surfaces arranged to be exposed to the ambient air, and a total surface area of the exterior surfaces of the passive heat exchanger members is greater than a surface area of the face of the eddy current-carrying portion.

3. The trolley of claim 2 wherein the passive heat exchanger members are arranged on a face of the eddy current-carrying portion opposite to the at least one wheel and exposed to an exterior of the housing.

4. The trolley of claim 2 wherein the passive heat exchanger members comprise fins projecting from the face of the proximal side plate and made from thermally conductive material.

5. The trolley of claim 4 wherein the fins extend longitudinally of the housing.

6. The trolley of claim 4 wherein each of the fins extends along a linear path on the face of the eddy current-carrying portion.

7. The trolley of claim 4 wherein the fins are arranged in side-by-side relation on the face of the eddy current-carrying portion.

8. The trolley of claim 4 wherein the fins are arranged on the face of the eddy current-carrying portion so that each adjacent pair of the fins forms a longitudinally extending duct on the face of the proximal side plate.

9. The trolley of claim 8 further including at least one longitudinally-extending covering member spanning between free tips of the fins to close the ducts.

10. The trolley of claim 9 wherein the at least one covering member forms an air-scoop delimiting an inlet opening outwardly of the free tips of the fins.

11. The trolley of claim 10 wherein the at least one covering member forms a plurality of air-scoops each delimiting an inlet opening outwardly of the free tips of the fins, the air-scoops being located at longitudinally spaced positions so as to provide a leading one of the air-scoops at a front end of the proximal side plate and at least one trailing air-scoop rearwardly thereof, and the inlet opening of said at least one trailing air-scoop being larger than the inlet opening of the leading one of the air-scoops.

12. The trolley of claim 2 wherein the passive heat exchanger members comprise thermally conductive bodies each defining an enclosed interior cavity containing a phase-change fluid, each thermally conductive body having a base portion in thermal contact with the eddy current-carrying portion and a free portion arranged in thermal contact with the ambient air, such that the phase-change fluid is enabled to receive heat from the eddy current-carrying portion at the base portion of the thermally conductive body and to release the heat at the free portion.

13. The trolley of claim 13 further including a duct member supported adjacent the thermally conductive bodies, wherein the duct member forms an air-scoop delimiting an inlet opening outwardly of the passive heat exchanger members.

14. The trolley of claim 1 wherein the at least one wheel is freewheeling.

15. The trolley of claim 1 wherein the eddy current-carrying portion is distinct from the proximal side plate.

16. The trolley of claim 15 wherein the eddy current-carrying portion is supported in a recess on an interior side of the proximal side plate adjacent the at least one wheel.

17. The trolley of claim 16 wherein the proximal side plate comprises one or more openings registered with the eddy current-carrying portion and the cooling system passes therethrough to an exterior of the housing.

18. A trolley for movement along a tensioned support member spanning from a first location to a second location, the trolley comprising:
a housing configured to receive the tensioned support member therethrough, wherein the housing comprises a pair of upstanding side plates supported in generally-parallel laterally spaced-apart relation and arranged on either side of the tensioned support member, wherein the side plates are metallic;
at least one wheel supported by the housing between the side plates, wherein the at least one wheel is configured for rolling engagement with the tensioned support member and is rotatable around a wheel axis which is laterally oriented; and
a braking system mounted to the at least one wheel and configured to induce eddy currents that act to oppose rotation of the at least one wheel, wherein the braking system comprises:
a plurality of magnetic assemblies respectively configured to generate magnetic fields, wherein the magnetic assemblies are supported on a respective one of the at least one wheel to rotate around the wheel axis therewith, wherein the magnetic assemblies are disposed in proximity to a proximal one of the side plates such that the magnetic fields of the magnetic assemblies passes through the proximal side plate;
wherein the magnetic assemblies are slidably movable relative to the respective wheel between an inactive position, in which the magnetic assemblies are located at inwardly spaced locations from a circumference of the at least one wheel, and a deployed position in which the magnetic assemblies are located radially outward from the inactive position;
wherein the magnetic assemblies are configured to move from the inactive position to the deployed position based on rotational speed of the respective wheel;
an inner annular portion on the proximal side plate shaped to follow a path followed by the magnetic assemblies when arranged in the inactive position, wherein the inner annular portion is arranged such that substantially no eddy currents are induced therein; and
an outer annular portion on the proximal side plate shaped to follow a path followed by the magnetic assemblies when arranged in the deployed position, wherein the outer annular portion is non-ferrous and electrically conductive such that eddy currents are inducible therein for opposing rotation of the respective wheel for braking thereof.

19. The trolley of claim 18 wherein the magnetic assemblies are slidably movable between the inactive and deployed positions radially of the at least one wheel.

20. The trolley of claim 18 wherein the inner annular portion has a larger radial spacing between inner and outer edges than a radial spacing of the outer annular portion between inner and outer edges thereof.

21. The trolley of claim 18 wherein the magnetic assemblies are carried on a support disc connected in fixed rotational relation to a respective one of the at least one wheel, wherein the magnetic assemblies are respectively slidably supported in slots in the support disc, wherein each of the magnetic assemblies comprises a magnetic device configured to generate a respective magnetic field of the magnetic assembly and a counterweight with substantially the same mass as the magnetic device, and wherein the magnetic device and counterweight are supported for sliding movement relative to the disc on opposite sides thereof.

22. The trolley of claim 18 wherein, when the magnetic assemblies are respectively slidably supported in slots in a support disc connected in fixed rotational relation to a respective one of the at least one wheel, the magnetic assemblies are respectively biased to the inactive position by biasing members received in the slots.

23. The trolley of claim 22 wherein the biasing members are compression springs respectively configured to resist movement of opposite ends thereof along a spring axis.

24. The trolley of claim 18 wherein the inner annular portion is integral with the proximal side plate.

25. The trolley of claim 18 wherein the outer annular portion is distinct from the proximal side plate and supported in a recess therein.

26. The trolley of claim 18 further including a cooling system thermally coupled to the outer annular portion to receive heat generated by the induced eddy currents.

27. The trolley of claim 26 wherein the proximal side plate comprises one or more openings registered with the outer annular portion so that the cooling system is passed through the one or more openings in the proximal side plate to an exterior of the housing.

28. The trolley of claim 18 wherein the inner and outer annular portions are both electrically conductive but made from different materials.
